(19) United States
(12) Patent Application Publication
(10) Pub. No.: US 2012/0208050 A1
(43) Pub. Date: Aug. 16, 2012

(54) LITHIUM-ION BATTERY

(75) Inventor: Gang CHEN, Hangzhou (CN)

(73) Assignee: HANGZHOU WANMA HIGH-ENERGY BATTERY CO., LTD., Hangzhou (CN)

(21) Appl. No.: 13/456,198

(22) Filed: Apr. 25, 2012

Related U.S. Application Data
(63) Continuation-in-part of application No. PCT/CN2010/002136, filed on Dec. 23, 2010.

(30) Foreign Application Priority Data
Dec. 31, 2009 (CN) 200920319341.X
Aug. 6, 2010 (CN) 201020291266.3

(51) Int. Cl. H01M 2/10; H01M 2/00; H01M 2/30

(52) U.S. Cl. 429/7; 429/99

(57) ABSTRACT

A lithium-ion battery specially used for starting motorcycles, including a positive terminal, a negative terminal, an open-mouthed rectangular can, and a cover matching the can. The positive terminal and negative terminal are both fixed on the cover and the cover is fixed on the can. The lithium-ion battery further comprises a cell assembly, a positive lead, a negative lead, a cell bracket and at least three support cushions. A positive electrode and a negative electrode are arranged in the cell assembly. One end of the positive lead is fixed on the positive terminal and the other end is fixed on the positive electrode of the cell assembly, and one end of the negative lead is fixed on the negative terminal and the other end is fixed on the negative electrode of the cell assembly.

### CROSS-REFERENCE TO RELATED APPLICATIONS

This application is a continuation-in-part of International Patent Application No. PCT/CN2010/002136 with an international filing date of Dec. 23, 2010, designating the United States, now pending, and further claims priority benefits to Chinese Patent Application No. 200920319341.X filed Dec. 31, 2009, and to Chinese Patent Application No. 201020291266.3 filed Aug. 06, 2010. The contents of all of the aforementioned applications, including any intervening amendments thereto, are incorporated herein by reference.

### CORRESPONDENCE ADDRESS

Inquiries from the public to applicants or assignees concerning this document should be directed to: MATTHIAS SCHOLL P.C., ATTN.: DR. MATTHIAS SCHOLL ESQ., 14781 MEMORIAL DRIVE, SUITE 1319, HOUSTON, Tex. 77079.

### BACKGROUND OF THE INVENTION

1. Field of the Invention

The invention relates to a lithium-ion battery, and more particularly to a lithium-ion battery specially used for starting motorcycles. As the lithium-ion battery is specially used for starting motorcycles, it forms an integral part of the motorcycles.

2. Description of the Related Art

Lead-acid batteries are mainly used to start motorcycles, but they have many disadvantages. On the one hand, lead-acid batteries have poor performance, for example, they are heavy in weight, low in specific energy, and short in service life; they also have low power and the starting current is approximately 10 C. On the other hand, since lead-acid batteries contain environmentally harmful substances such as heavy metals (e.g. lead) and sulfuric acid, environmental pressure is increasing when lead-acid batteries are used for motorcycles.

As lead-acid batteries specially used for starting motorcycles have certain requirements on specifications and performance, for instances, the voltage for such lead-acid battery is generally 12 V, the lead-acid batteries are mounted in a space of a certain size on motorcycles, one specification of lead-acid battery is only applicable to a certain model of motorcycle and different specifications of lead-acid batteries are incompatible with the same motorcycles. In other words, once the lead-acid batteries for starting motorcycles are damaged, only the same specifications of the lead-acid batteries can be replaced at present. As motorcycles with different engine displacements are required, lead-acid batteries for starting the motorcycles have greatly varied capacities accordingly. Moreover, due to the fact that lead-acid batteries having the same capacity are restricted by different mounting spaces on different models of motorcycles, the lead-acid batteries now have about 100 different sizes and 400 specifications. Consequently, large-scale mechanized production of lead-acid batteries cannot be achieved as a result of large investment in moulds, complicated production management and various materials.

Furthermore, when used for racing, motorcycles are required to be lighter and faster. But the gravimetric specific energy of a lead-acid battery is 1/4 of that of a lithium-ion battery while the weight is 4 times heavier than that of a lithium-ion battery; therefore the weight of a motorcycle is increased and more oil consumption is required accordingly.

Under the requirement of compact structure for motorcycles as a whole, lead-acid batteries with sufficient capacity and starting performance cannot be mounted in the limited spaces during the design. This is one of the difficulties for structural innovation of motorcycles. Apart from that, the volumetric specific energy of a lead-acid battery is ⅓ of that of a lithium-ion battery.

At present, among all motorcycle starting batteries, there is not a new type of starting battery that is light and environmental friendly and which has a long service life and high specific energy to replace all conventional lead-acid batteries. In addition, such battery must have fewer specifications and moulds. There is an industrial tendency to develop a new type of battery and the new type of battery will have a broad market prospect.

### SUMMARY OF THE INVENTION

In view of the above-described problems, it is one objective of the invention to provide a lithium-ion battery specially used for starting motorcycles. The battery is reasonably designed, energy-saving, and environmental friendly and meanwhile it has a long service life, excellent discharge performance, and a strong barrier-free replacement capability.

To achieve the above objective, in accordance with one embodiment of the invention, there provided is a lithium-ion battery specially used for starting motorcycles, comprising a positive terminal, a negative terminal, an open-mouthed rectangular can, and a cover matching the can, wherein the positive terminal and the negative terminal are both fixed on the cover and the cover is fixed on the can; the lithium-ion battery further comprises a cell assembly, a positive lead, a negative lead, a cell bracket and at least three support cushions; the cell assembly comprising four lithium-ion cells in series is mounted on the cell bracket, the support cushion is arranged between two adjacent lithium-ion cells, and a positive electrode and a negative electrode are arranged in the cell assembly; one end of the positive lead is fixed on the positive terminal and the other end is fixed on the positive electrode of the cell assembly; one end of the negative lead is fixed on the negative terminal and the other end is fixed on the negative electrode of the cell assembly; and the cell bracket is mounted in the can.

In a class of this embodiment, the can comprises a battery mounting chamber, the positive terminal and/or the negative terminal is arranged with an insulation sleeve, respectively, and the cell bracket is mounted in the battery mounting chamber. The cell assembly comprises four 3.2 V lithium-ion cells in series and the four lithium-ion cells are parallel with one another. The lithium-ion cells are all lithium iron phosphate batteries, a clearance is arranged between two adjacent lithium-ion cells and each clearance is arranged with at least one support cushion. A waterproof mechanism is arranged between the can and the cover. Such a structure allows the lithium-ion battery provided by the invention to be specially used for starting motorcycles because the lithium-ion battery is light, environmental friendly, and long in service life and meanwhile it does not produce lead pollution either in the manufacturing process or in actual applications.

In a class of this embodiment, the waterproof mechanism comprises a waterproof groove and a waterproof raised bar, in which the waterproof groove is arranged on the top of the can and the waterproof raised bar that matches the waterproof groove is arranged at the bottom of the cover. The waterproof raised bar is embedded in the waterproof groove. Such a structure makes the waterproof mechanism provided by the invention more simple and the waterproof mechanism can be easily manufactured and has a better waterproof effect.

In a class of this embodiment, the cell bracket comprises four bracket bodies and each bracket body is arranged with a four-layer cavity that is in the shape of a right triangular prism. The bottom of the cavity is in the shape of a right triangle. The four layers of the cavities in each bracket body overlap with one another. Each cavity comprises an inlet, which is opposite to the right angle of the right triangle of that cavity. Four angles of each lithium-ion cell are separately mounted in the cavity at the same level in four bracket bodies. It makes the structure of the lithium-ion battery provided by the invention more reasonable and four lithium-ion cells can be more effectively mounted on the cell bracket.

In a class of this embodiment, four slots are disposed on the inner wall of the battery mounting chamber. The four bracket bodies matching the four slots are clamped in the slots, respectively. Such a structure allows the cell bracket of the lithium-ion battery provided by the invention to be more easily and firmly mounted in the battery mounting chamber of the can, thus the whole performance of the lithium-ion battery is improved.

In a class of this embodiment, two opposite inner walls of the battery mounting chamber are respectively arranged with two first raised bars extending from the bottom to the top of the battery mounting chamber along its inner walls. The end of the first raised bar curves in its raised direction to form four slots that match the bracket bodies. The other two opposite inner walls of the battery mounting chamber are respectively arranged with two columns extending from the bottom to the top of the battery mounting chamber along its inner walls. At least one of the two columns has a second raised bar extending in the axial direction of that column. The end of the second raised bar curves in its raised direction to form two limit raised bars that match the bracket bodies. The slots and the limit raised bars are used to fix the bracket bodies.

In a class of this embodiment, two opposite inner walls of the battery mounting chamber are respectively arranged with two raised bars extending from the bottom to the top of the battery mounting chamber along its inner walls. The end of the raised bars curves in its raised direction to form four slots that match the bracket bodies. The other two opposite inner walls of the battery mounting chamber are respectively arranged with two columns extending from the bottom to the top of the battery mounting chamber along its inner walls. The other two opposite inner walls of the battery mounting chamber are arranged with a limit plate that extends from the bottom to the top of the battery mounting chamber along its inner walls and which is between the two columns and meanwhile close to one of the columns. The slots and the limit plate are used to fix the bracket bodies.

In a class of this embodiment, the lithium-ion battery further comprises bases, which are fixed at the bottom of the can. The bottom of the cover is arranged with a plurality of locating convex blocks, which hold the cell bracket. The bases are designed to meet various circumstances that different specifications of the batteries are required, so that the batteries have wider applications and can be freely combined into different sizes to replace different models of the lead-acid batteries available for motorcycles.

In a class of this embodiment, the positive terminal and the negative terminal are both fixed on the cover by injection molding. One end of the positive lead and the negative lead is fixed on the positive terminal and the negative terminal by screws, respectively. Consequently, the positive terminal and the negative terminal can be more securely fixed on the cover, thus the whole structure of the lithium-ion battery becomes more reliable. Moreover, as one end of the positive lead is fixed on the positive terminal and one end of the negative lead is fixed on the negative terminal by screws, the length of the positive lead and the negative lead can be controlled in the shortest range, which helps to improve the starting performance of the lithium-ion battery provided by the invention.

In a class of this embodiment, four lithium-ion cells in the cell assembly are in the shape of a flat rectangle and overlap with one another. Such a structure make the four lithium-ion cells mounted on the cell bracket have better anti-vibration performance and heat dissipation performance. It effectively prevents deformation of the lithium-ion cells, thus the lithium-ion battery provided by the invention is improved in terms of better performance and prolonged service life.

In a class of this embodiment, the lithium-ion battery also comprises a seal ring matching the waterproof groove and the seal ring is mounted in the waterproof groove of the can. Such a structure make the lithium-ion battery provided by the invention have a better waterproof performance and the whole performance of the lithium-ion battery is improved accordingly.

In a class of this embodiment, the lithium-ion battery also comprises a plurality of fixed screws and the can is arranged with matching through holes. The through holes are perpendicular to the bottom of the can. The upper end of each through hole is on the top of the can and the lower end is at the bottom of the can. The bottom of the cover is arranged with blind holes matching the through holes. The cover is fixed on the can via the fixed screws and the fixed screws go through the through holes and the blind holes. In this manner, the structure of the lithium-ion battery provided by the invention is simpler and more secure. The lithium-ion battery can be easily assembled and disassembled and the whole structure is more reasonable.

In a class of this embodiment, the through holes are located at the center of the columns and extend through the whole columns in the axial direction of the columns.

In a class of this embodiment, the battery mounting chamber of the can is arranged with a wire duct matching the positive lead and the negative lead, which are both in the wire duct. The four lithium-ion cells in the cell assembly are connected in series via a patch panel or connecting wires. In this manner, the structure of the lithium-ion battery provided by the invention is more reasonable. The positive lead and the negative lead can be easily wired, the positive lead and the negative lead are unlikely to be pressed by the can and the cell bracket can be easily mounted in the battery mounting chamber of the can.

In a class of this embodiment, the bottom of the can is arranged with a fixed support, which is used to heighten the cell bracket and which is in the shape of a “#”, “X”, or parallel lines. Such a structure makes it easier for the cell bracket to be mounted in the can. When a “#” shaped fixed support is adjustable, different models of the cell assemblies can be mounted, therefore the lithium-ion battery has extended its applicability.

In a class of this embodiment, the can or the cover is arranged with an equalization circuit, which is connected with the cell assembly by means of the connecting wires.

In a class of this embodiment, the bracket bodies are in the shape of a right triangular prism and two adjacent bracket bodies can be coupled by reinforced ribs and/or tapes. It enables the bracket bodies provided by the invention to be securely coupled and the bracket bodies are safer, more stable and reliable when they are used.

In a class of this embodiment, one right-angle side of the right triangular prism is closely against the inner wall of the can.

In a class of this embodiment, one side of each base is arranged with a fixed hole and the opposite side is arranged with a support leg, which is fixedly coupled to the fixed hole at the outer bottom of the can. The adjacent bases are fixedly coupled together by the support legs and the fixed holes on the bases. Such a structure is convenient for disassembly to form different sizes as required.

Compared with the prior art, advantages of the invention are summarized below:
1. The dimensions of the can and the cover used in the invention are consistent with those for a standard battery can used for motorcycles and the lithium-ion battery provided by the invention can freely replace conventional lead-acid batteries. Moreover, the bases with different height are combinable with the same type of the lithium-ion battery can to form different types of the lithium-ion batteries so as to replace different models of the lead-acid batteries used currently for motorcycles; therefore, fewer moulds for plastic cans are required.
2. The cell assembly is mounting friendly and its components are simple in structures and low in production costs. The inner structure assembly is flexible, adjustable and reliable and meanwhile has strong applicability.
3. Light and the total weight is ⅓ of that for a conventional lead-acid starting battery.
4. It is environmental friendly and free of pollution problems caused by heavy metals such as lead, cadmium, mercury and the like.
5. It has an extra high power and the starting current is over 40 C.
6. It has extra long cycle life and number of times for charging/discharging is over 2000.
7. It is highly reliable and free of safety issues such as explosion and ignition.

The top of the can of the lithium-ion battery provided by the invention is arranged with a waterproof groove and a waterproof raised bar matching the waterproof groove is mounted at the bottom of the cover. When the cover is fixed on the can, the waterproof raised bar is embedded in and closely contact with the waterproof groove to ensure that the lithium-ion battery has excellent sealing performance to prevent rainwater from entering the can, thus the safety performance of the lithium-ion battery is improved and the service life is significantly prolonged. The bottom of the cover of the lithium-ion battery provided by the invention is arranged with a plurality of locating convex blocks. When the cover is fixed on the can, the locating convex blocks hold the cell bracket to enable it to be properly fixed in the battery mounting chamber. The positive terminal and the negative terminal are arranged with insulation sleeves so as to prevent short circuit of the lithium-ion battery provided by the invention during the transport, so that the safety is improved and the lithium-ion battery can be transported easily.

Lithium-ion batteries, especially lithium iron phosphate batteries such as lithium iron phosphate polymer lithium ion batteries with high magnifications, have high energy density, contain no heavy metals such as lead, cadmium and mercury, have higher power density than lead-acid batteries, and meanwhile they are highly reliable. They are the preferred starting batteries to replace conventional lead-acid batteries. Conventional lithium-ion battery cans are divided into two large categories: metal cans and aluminium-plastic composite film cans. Since the soft aluminium-plastic composite film has better safety performance, it is more suitable for the starting batteries. However, as the aluminium-plastic composite film has insufficient strength itself, the cell bracket is then applied in the invention to support the lithium-ion battery to make its inner structure more robust and reliable.

Among the four lithium-ion cells provided by the invention, the voltage of an individual lithium-ion cell is 3.2 V. If the four lithium-ion cells are connected in series, the voltage is 12.8 V, which is just enough to start motorcycles, therefore the lithium-ion battery provided by the invention is able to be used to start motorcycles. The dimensions of the can used in the invention are the same as those for a conventional lead-acid battery used for starting motorcycles. When a starting battery is required to be replaced for a motorcycle in use, the place for mounting that starting battery fits for the can itself or the combination between the can and different sizes of the bases. Consequently, the motorcycle needs no reconfiguration and the conventional starting batteries can be replaced freely. It is helpful for popularization of the invention. The four bracket bodies used in the invention can be made into standard parts to suit for hundreds of different sizes of starting batteries and meanwhile to save more materials and more costs on moulds.

The lithium-ion battery provided by the invention is of great advantage to environmental protection. It causes no lead pollution during the applications and it has a broad market prospect. The lithium-ion battery has long service life and better discharge performance, which is helpful to improve overall performance of motorcycles.

### BRIEF DESCRIPTION OF THE DRAWINGS

FIG. 1 is a front view of a lithium-ion battery without an insulation sleeve in accordance with example 1 of the invention;

FIG. 2 is a left view of FIG. 1;

FIG. 3 is a structural representation of a separated cover and can of FIG. 1;

FIG. 4 is a structural representation of a lithium-ion battery's cover bottom in accordance with example 1 of the invention;

FIG. 5 is a top view of a can in accordance with example 1 of the invention;

FIG. 6 is a rear view of FIG. 5;

FIG. 7 is an enlarged front view of a cell assembly mounted on a cell bracket in accordance with example 1 of the invention;

FIG. 8 is a top view of FIG. 7;

FIG. 9 is a structural representation of FIG. 7 without a cell bracket;

FIG. 10 is a front view of a lithium-ion battery without an insulation sleeve in accordance with example 2 of the invention;

FIG. 11 is a top view of FIG. 10;

FIG. 12 is a structural representation of a cover bottom in accordance with example 2 of the invention;

FIG. 13 is a top view of a can in accordance with example 2 of the invention;

FIG. 14 is an enlarged structural representation of a cell assembly mounted on a cell bracket in accordance with example 2 of the invention;

FIG. 15 is a top view of FIG. 14;

FIG. 16 is a structural representation of FIG. 14 without a cell bracket;

FIG. 17 is an enlarged structural representation of a bracket body of a cell bracket in accordance with example 2 of the invention;

FIG. 18 is a left view of FIG. 17;

FIG. 19 is a top view of FIG. 17;

FIG. 20 is a sectional view of A-A side of FIG. 17;

FIG. 21 is a structural representation of FIG. 19 after clockwise rotation of 45°;

FIG. 22 is a bottom view of FIG. 21;

FIG. 23 is a structural representation of an equalization circuit board and a cell assembly in accordance with the invention;

FIG. 24 is a structural representation of an equalization circuit board and a can in accordance with the invention;

FIG. 25 is a structural representation of a base in accordance with the invention; and

FIG. 26 is a bottom view of a base in accordance with the invention.

### DETAILED DESCRIPTION OF THE EMBODIMENTS

The invention is explained in further detail below with the reference to the embodiments and attached drawings. It should be noted that the following embodiments are intended to describe and not to limit the invention.

### Example 1

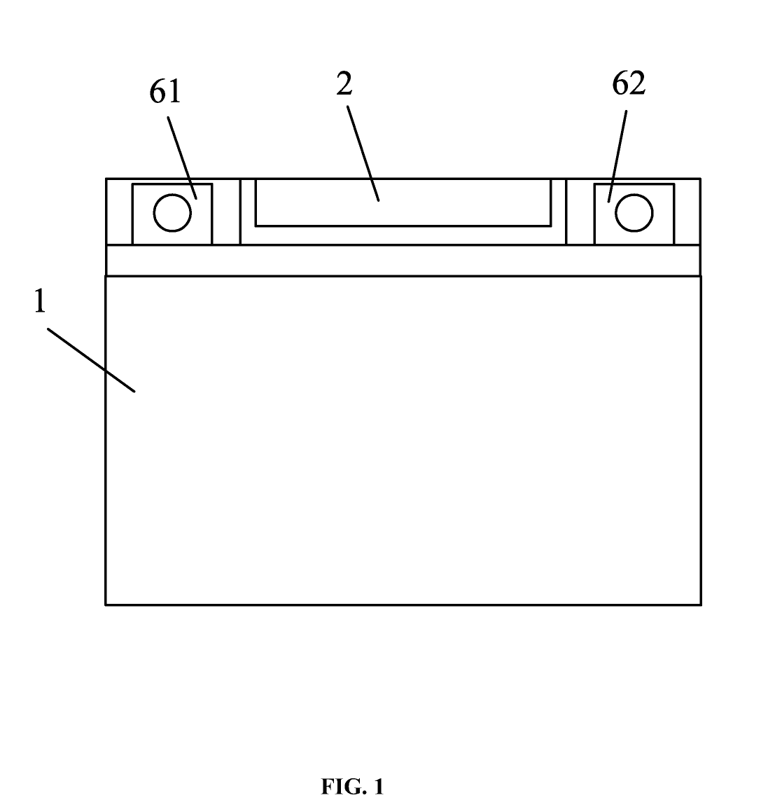

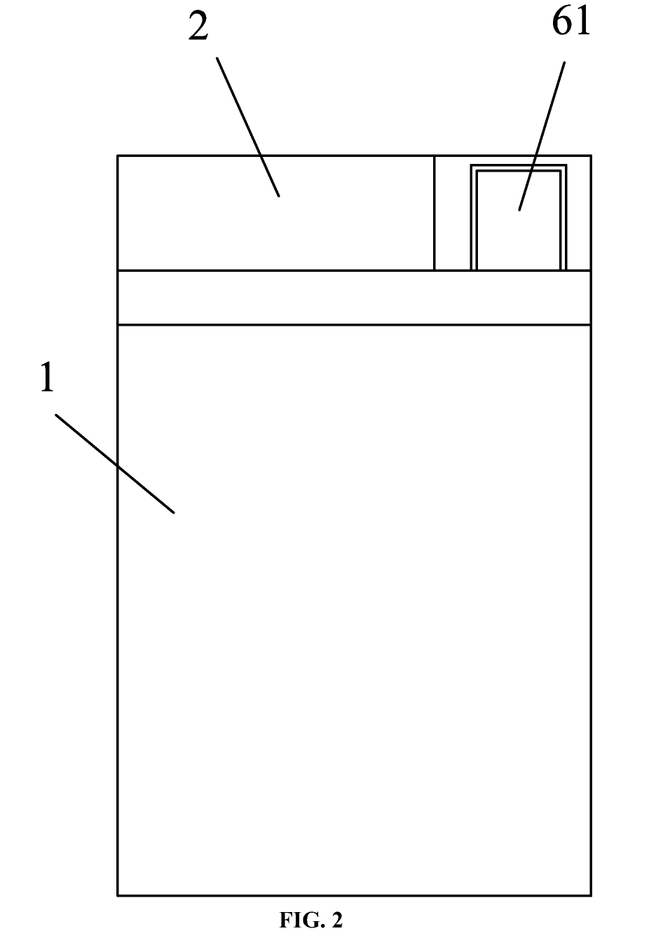

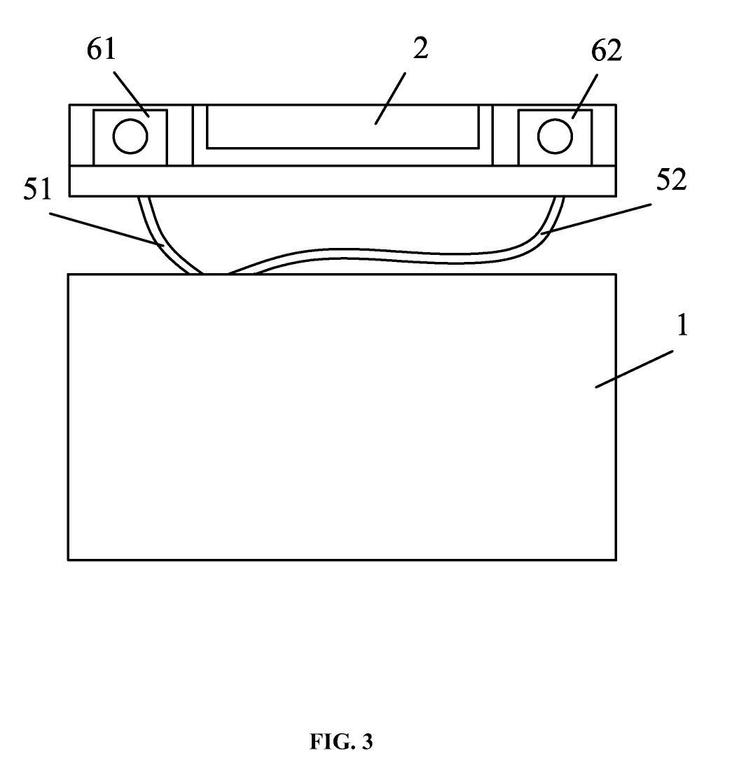

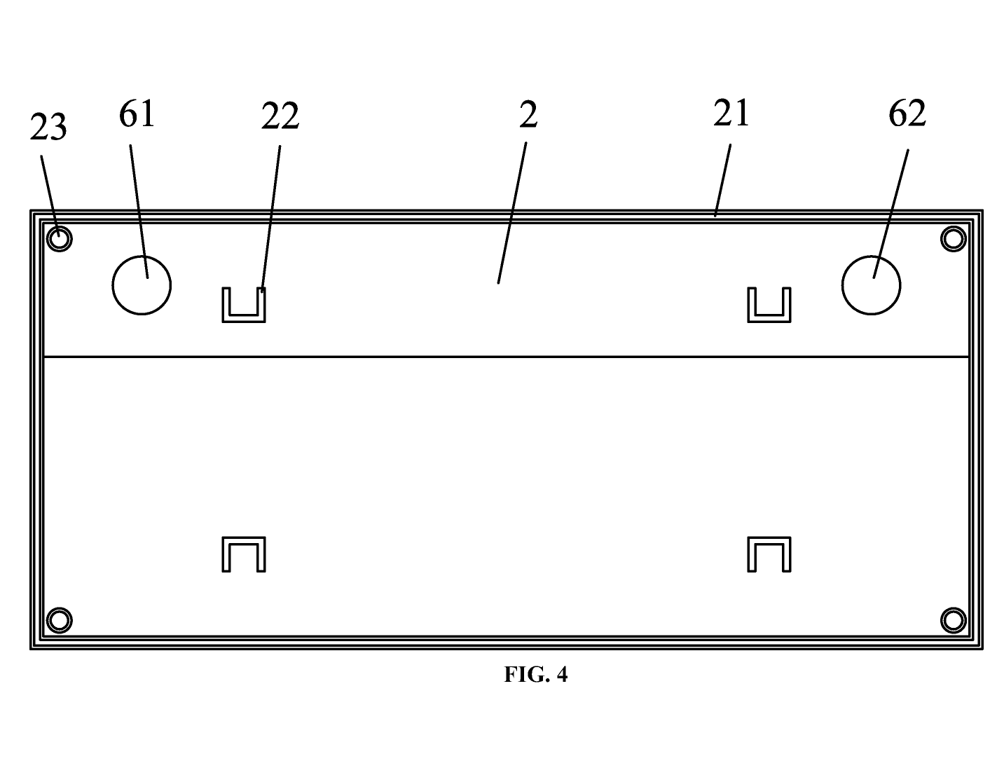

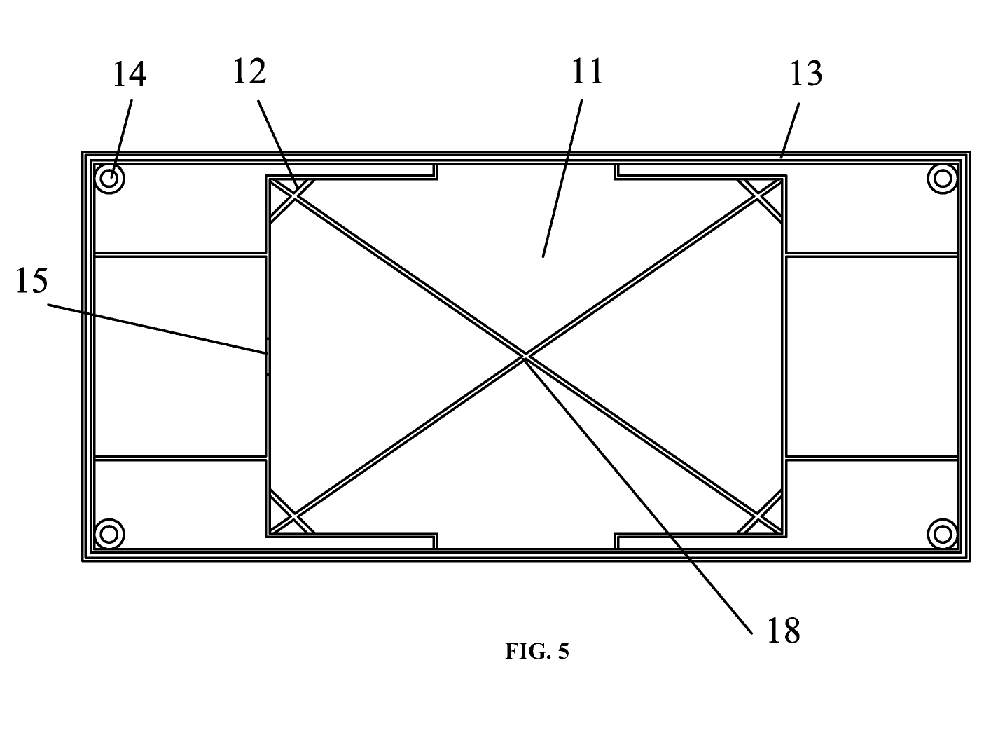

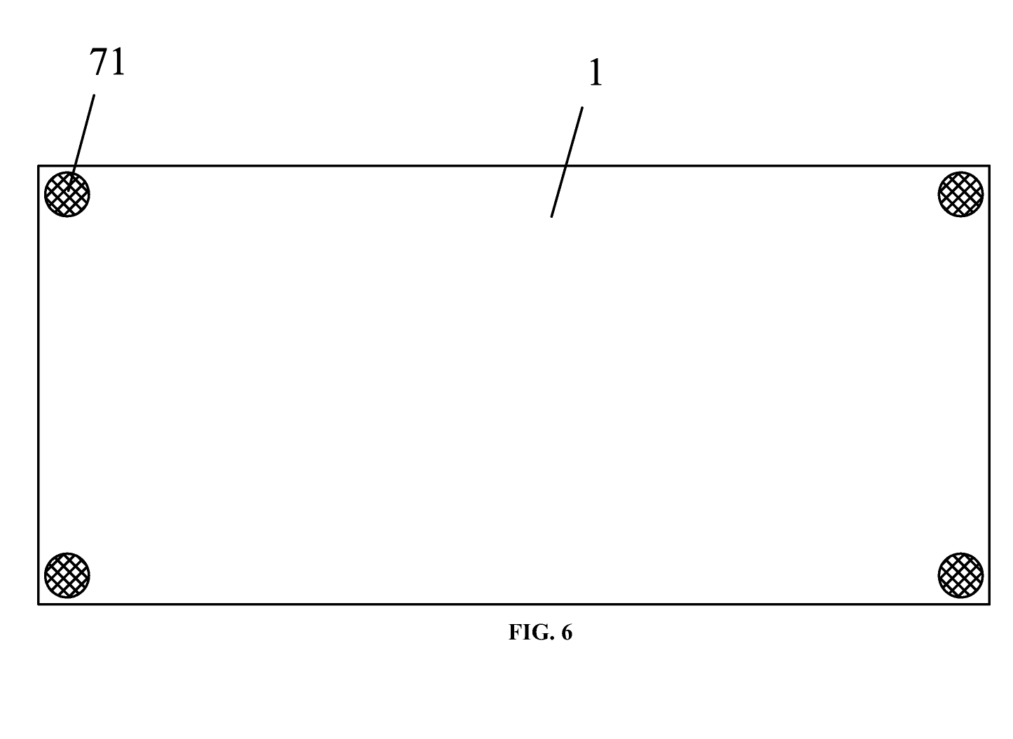

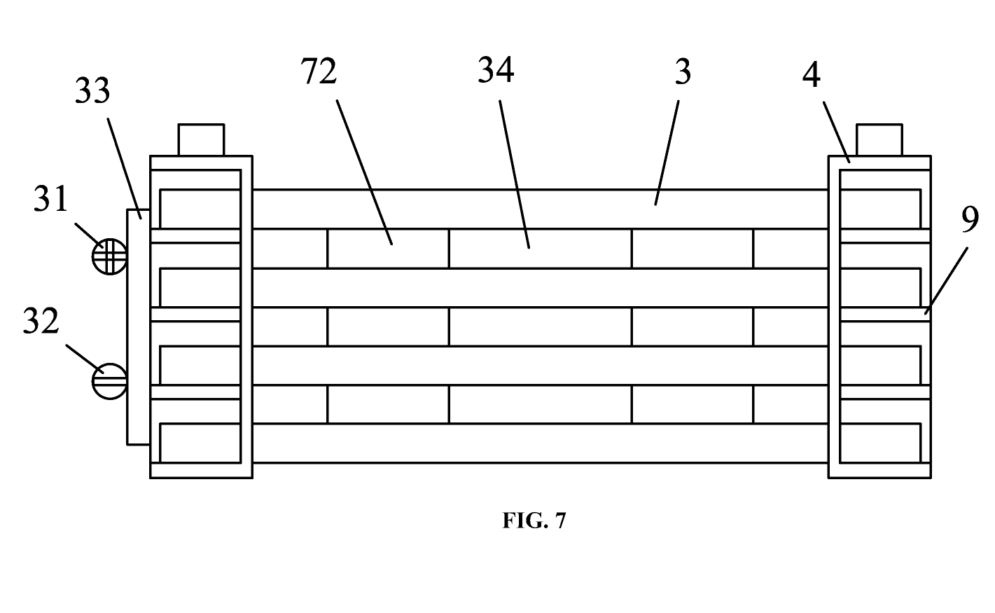

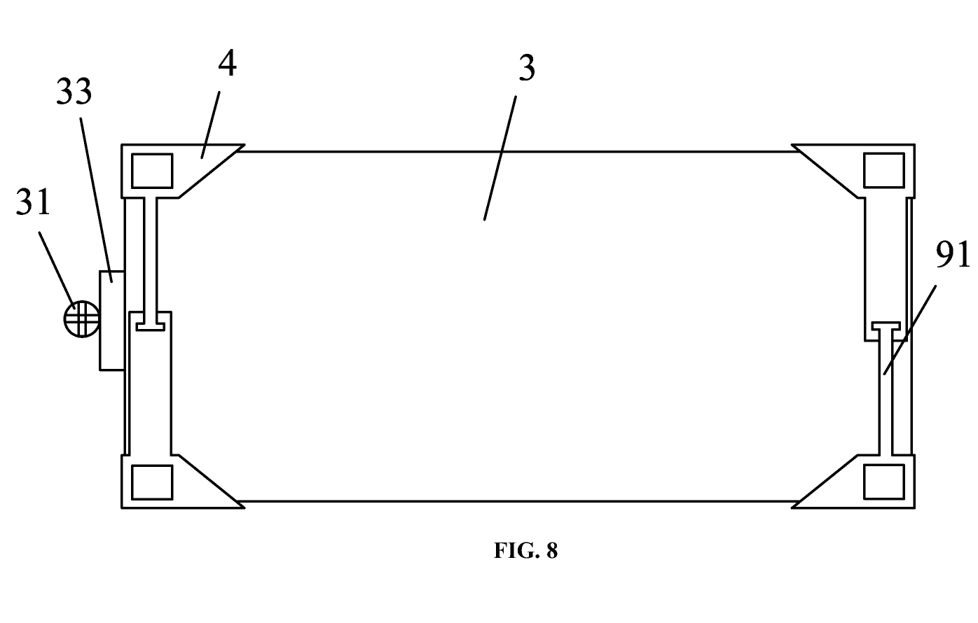

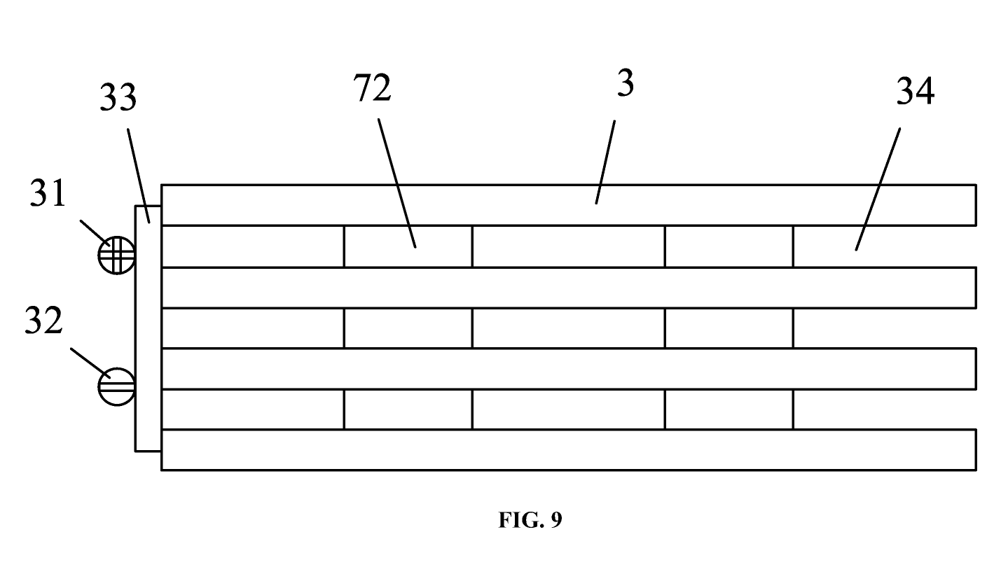

As shown in FIGS. 1-9, a lithium-ion battery specially used for starting motorcycles, in accordance with the invention, comprises a can 1, a cover 2, a cell assembly 3, a cell bracket 4, a positive lead 51, a negative lead 52, a positive terminal 61, a negative terminal 62, insulation sleeves, four fixed screws, four resistance cushions 71, seal rings and six support cushions 72, in which the cell assembly 3 comprises four 3.2 V lithium-ion cells in series via a patch panel 33 to allow the voltage of the cell assembly 3 to be 12.8 V. It is the voltage that a motorcycle requires to start and the lithium-ion battery provided by the invention can be specially used for starting motorcycles. The bottom of the can 1 is arranged with an x-shape fixed support 18 and the cell bracket 4 can be fixed thereon. The x-shape fixed support 18 is used to mount the cell bracket 4 and it is optionally adjustable to accommodate different sizes of the cell bracket 4, thus the applicability of the lithium-ion battery provided by the invention is extended. The four lithium-ion cells of the cell assembly 3 are in the shape of a flat rectangle and they are all lithium iron phosphate batteries. The cans of the four lithium-ion cells are of aluminium-plastic composite film, they are parallel and overlap with one another. Two adjacent lithium-ion cells form a clearance 34, which is helpful for heat dissipation of the cell assembly 3. The cell assembly 3 comprises a positive electrode 31 and a negative electrode 32. In this example, the cell assembly 3 is mounted on the cell bracket 4 and the clearance 34 formed by two adjacent lithium-ion cells is arranged with two support cushions 72. The four lithium-ion cells mounted on the cell bracket 4 have better anti-vibration performance and heat dissipation performance. The support cushions 72 can provide sufficient support and effectively prevent deformation of the lithium-ion cells. In this example, two support cushions 72 are in a group and there are three groups of the support cushions 72. The cell bracket 4 and the cell assembly 3, in accordance with the invention, can be fixed by tapes, for example, wrap the tape around the cell bracket 4 and the cell assembly 3 to reinforce the structure therebetween to allow the cell assembly 3 to be securely fixed on the cell bracket 4. The technology adopted for the lithium iron phosphate batteries is the same as or similar to the prior art. The cell bracket 4 in this example comprises four bracket bodies 9 and two adjacent bracket bodies 9 can be reinforced by a reinforced rib 91, for example, apply an extension piece 91 to the bracket bodies 9. The reinforced rib is formed by connecting the extension pieces 91 on two adjacent bracket bodies 9 together through thermal sealing or bonding, therefore, the lithium-ion cells can be securely fixed on the cell bracket. Alternatively, the four bracket bodies 9 may also be reinforced by using tapes and reinforced ribs at the same time.

The positive terminal 61 and the negative terminal 62 are fixed on the cover 2 by injection molding, which enables the positive terminal 61 and the negative terminal 62 to be more securely fixed on the cover 2. The positive terminal 61 and the negative terminal 62 are both mounted with insulation sleeves so as to prevent short circuit of the lithium-ion battery specially used for starting motorcycles during the transport, so that the safety of the lithium-ion battery provided by the invention is ensured. Furthermore, the insulation sleeve can be mounted either on the positive terminal 61 or on the negative terminal 62 and the insulation sleeves provided by the invention is the same as or similar to those provided in the prior art. One end of the positive lead 51 is fixed on the positive terminal 61 by screws and the other end is fixed on the positive electrode 31 of the cell assembly 3 while one end of the negative lead 52 is fixed on the negative terminal 62 by screws and the other end is fixed on the negative electrode 32 of the cell assembly 3, therefore the length of the positive lead 51 and the negative lead 52 can be controlled in the shortest range. The shorter the length of the positive lead 51 and the negative lead 52, the better the starting performance of the lithium-ion battery specially used for starting motorcycles in accordance with the invention. As a result, one end of the positive lead 51 and the negative lead 52 fixed on the positive terminal 61 and the negative terminal 62 by screws, respectively, helps to improve the starting performance of the lithium-ion battery specially used for starting motorcycles in accordance with this example.

The can 1 is in the shape of an open-mouthed rectangular. The dimensions of the can 1 provided by the invention are the same as those for the cans of conventional lead-acid batteries, i.e. the standard cans for motorcycles. In other words, the lithium-ion battery provided by the invention can freely replace conventional lead-acid batteries. The can 1 comprises a battery mounting chamber 11, in which a cell bracket 4 is arranged together with a wire duct 15 matching the positive lead 51 and the negative lead 52. When the cell assembly 3 is mounted in the battery mounting chamber 11 with the cell bracket 4, the positive lead 51 and the negative lead 52 are both in the wire duct 15 so as to prevent them from being pressed by the cell assembly 3 and the can 1. Therefore the positive lead 51 and the negative lead 52 can be easily wired, which means that the lithium-ion battery can be conveniently mounted and disassembled. A round of a complete waterproof groove 13 is arranged on the periphery of the top of the can 1. The waterproof groove 13 is in the shape of a rectangle matching the shape and size of the seal ring. The seal ring is embedded in and closely contact with the waterproof groove 13. Alternatively, the waterproof groove 13 may not be complete and it can be separated into several segments, as long as it can cooperate with the cover 2 to prevent penetration by water.

The can 1 is arranged with four through holes 14, perpendicular to the bottom of the can 1. The upper end of each through hole 14 is on the top of the can 1 and the lower end is at the bottom of the can 1. In this example, the four resistance cushions 71, matching the four through holes 14, are separately fixed at the lower end of the four through holes 14. In other words, the resistance cushions 71 are fixed at the bottom of the can 1. The bottom of each resistance cushion 71 is arranged with resistance strips, which are laid out in a grid pattern and which are used to provide buffering and increase resistance, so that the lithium-ion battery provided by the invention can be stably mounted in motorcycles. Alternatively, the resistance strips may not be arranged at the bottom of the resistance cushions 71 used in the invention because the resistance cushions are made of rubber, their bottoms are flat and they have excellent resistance increasing effects.

The bottom of the cover 2 is arranged with four blind holes 23, matching the through holes 14 of the can 1. The blind holes 23 and the through holes 14 match the fixed screws, which go through the blind holes 23 and the through holes 14 to fix the cover 2 on the can 1. Since the resistance cushions 71 are fixed at the bottom of the through holes 14, after the fixed screws go through the through holes 14, the resistance cushions 71 can provide sealing for the through holes 14 to prevent rainwater from entering into the can 1 through the through holes 14. It makes the structure of the lithium-ion battery provided by the invention more reasonable. In this example, the bottom of the cover 2 is also arranged with four locating convex blocks 22 and a round of complete waterproof raised bar 21. The shape and size of the waterproof raised bar 21 matches the waterproof groove 13 of the can 1. When the cover 2 is fixed on the can 1 by the fixed screws, the waterproof raised bar 21 is embedded in and closely contact with the waterproof groove 13. It is able to provide an excellent sealing effect between the cover 2 and the can 1 so as to prevent rainwater from entering into the can 1 through the cover 2, thus the service life of the lithium-ion battery provided by the invention is prolonged. Moreover, the surfaces of the waterproof raised bar 21 and the waterproof groove 13 can be roughened to ensure tighter sealing therebetween. After the cover 2 is fixed on the can 1 by the fixed screws, the four locating convex blocks 22 arranged at the bottom of the cover 2 hold the cell bracket 4 to allow it to be securely fixed in the battery mounting chamber 11 of the can 1. Alternatively, the waterproof raised bar 21 may not be complete and it can be separated into several segments, as long as it can cooperate with the waterproof groove 13 at the top of the can 1 to provide an excellent sealing effect between the cover 2 and the can 1.

A waterproof mechanism arranged between the can 1 and the cover 2 is described below: the top of the can 1 is arranged with a round of complete waterproof groove 13, and the bottom of the cover 2 is arranged with a round of complete waterproof raised bar 21 that matches the waterproof groove 13. The waterproof mechanism used in the invention can also use other structures. For example, a round of complete waterproof raised bar 21 can be arranged on top of the can 1 and a round of complete waterproof groove 13, matching the waterproof raised bar 21, can be arranged at the bottom of the cover 2. The preferred number of the resistance cushions 71 used in the invention is four, the number of the blind holes 23 is the same as that of the fixed screws, and the number of the through holes 14 is the same as that of the resistance cushions 71. Optionally, a base can be arranged at the bottom of the can 1, in accordance with the invention, to adjust the overall height of the can 1 so as to extend the applicability of the lithium-ion battery.

### Example 2

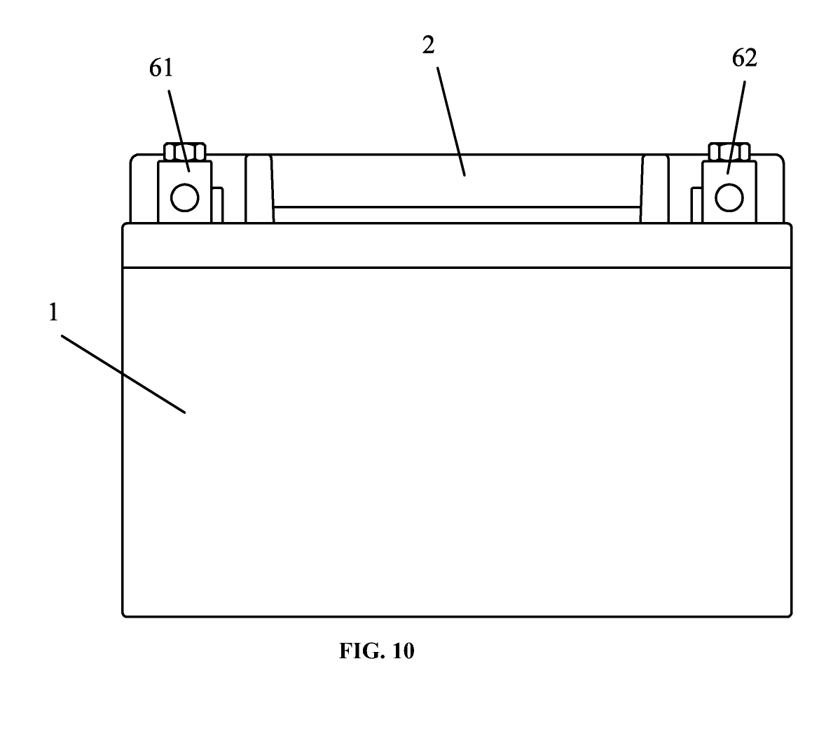

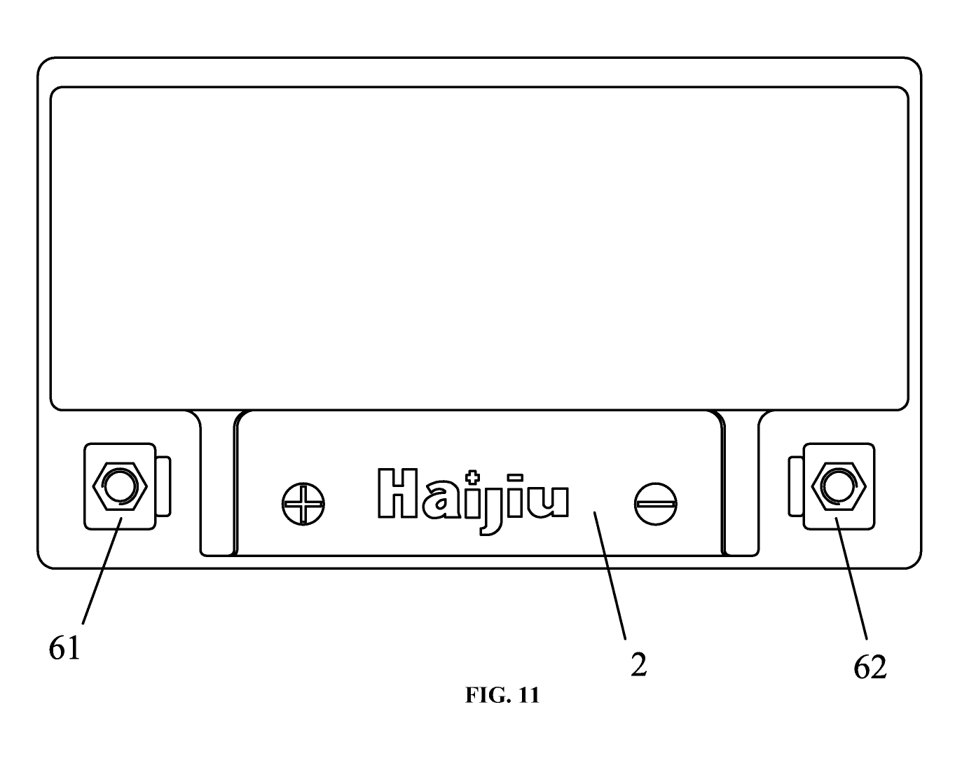

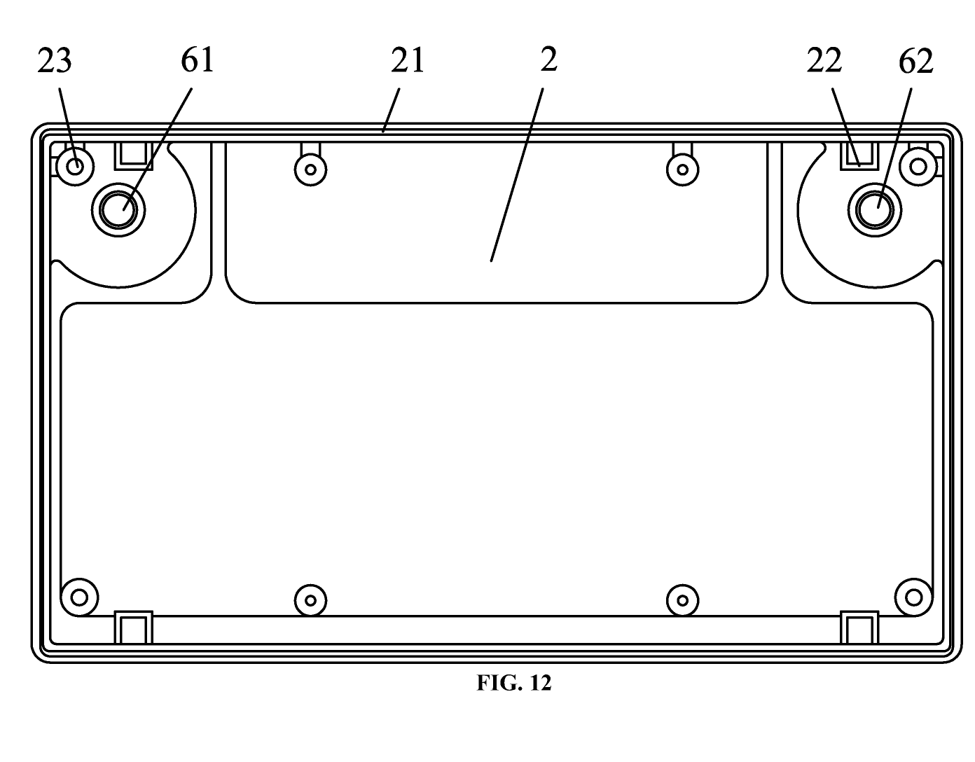

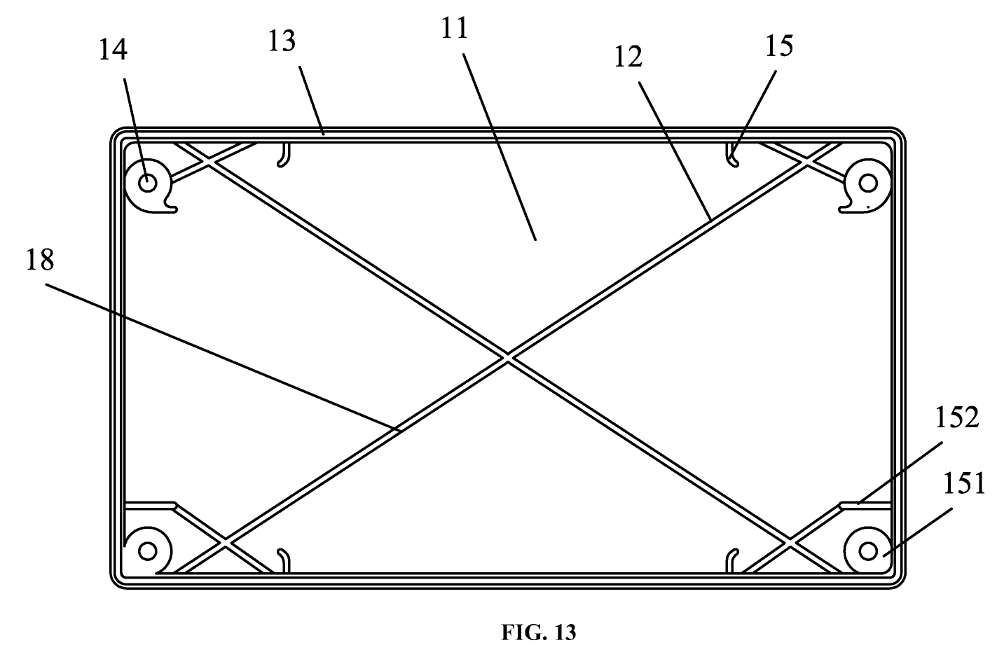

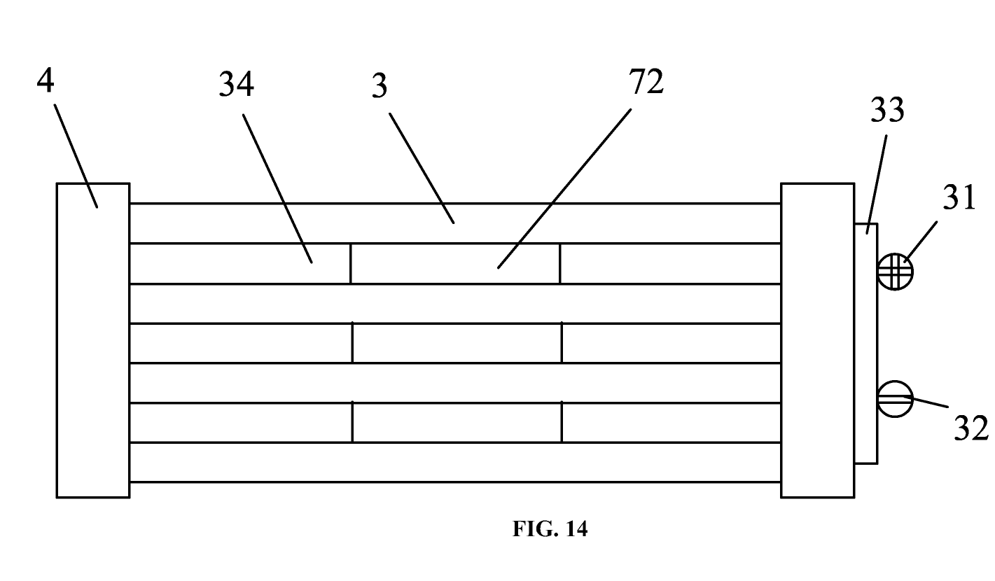

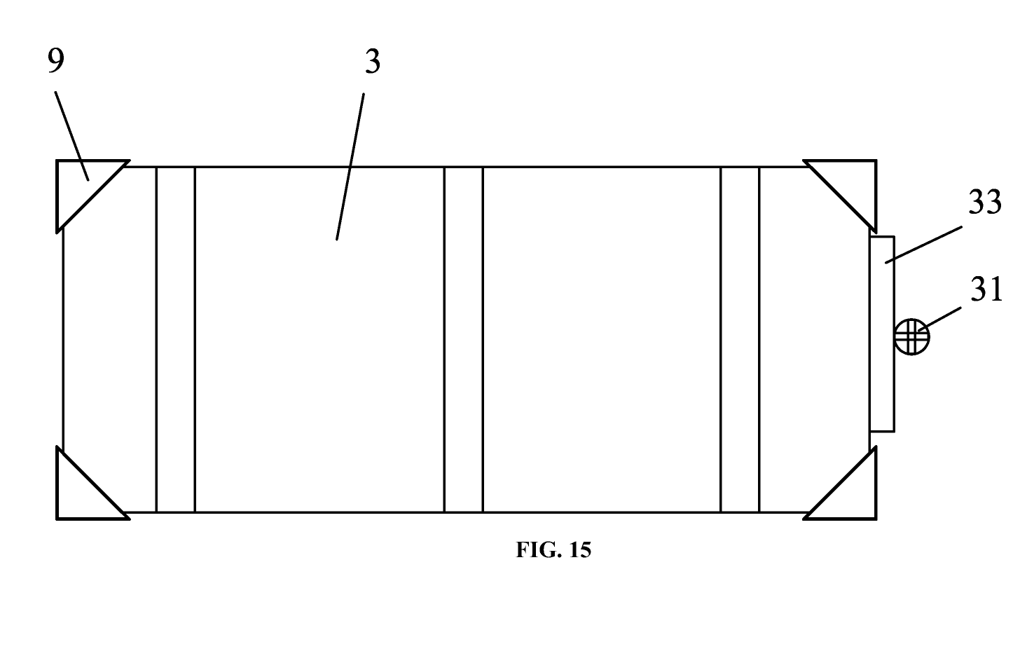

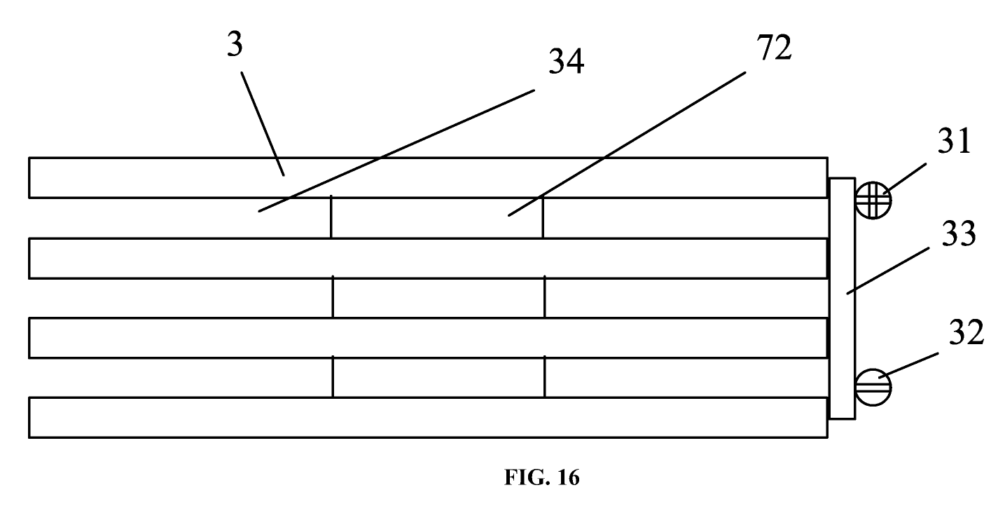

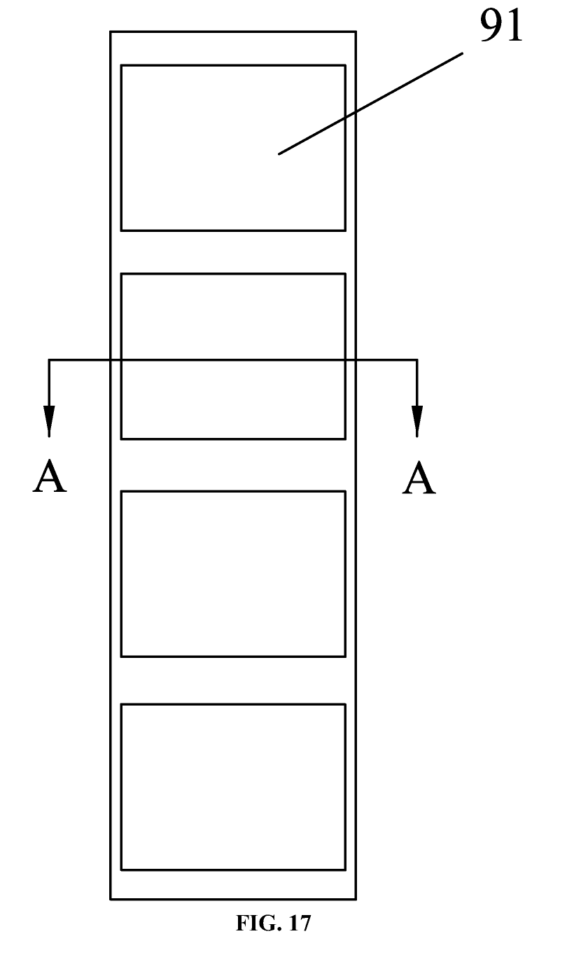

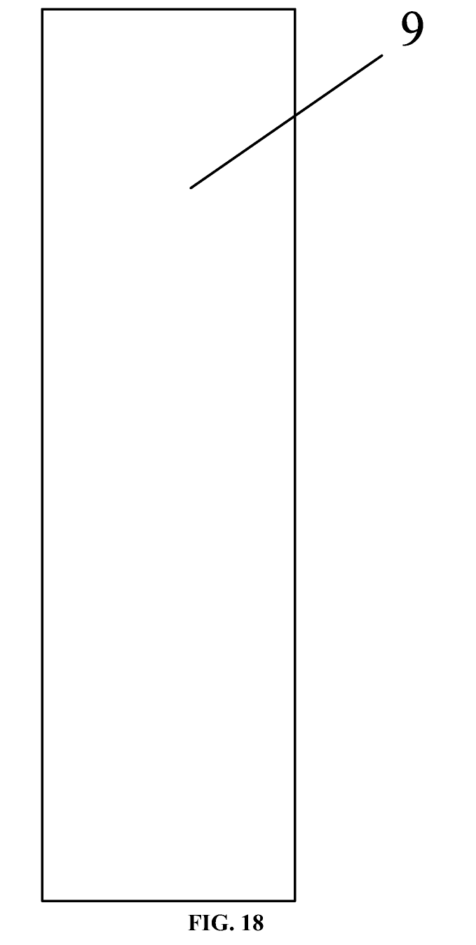

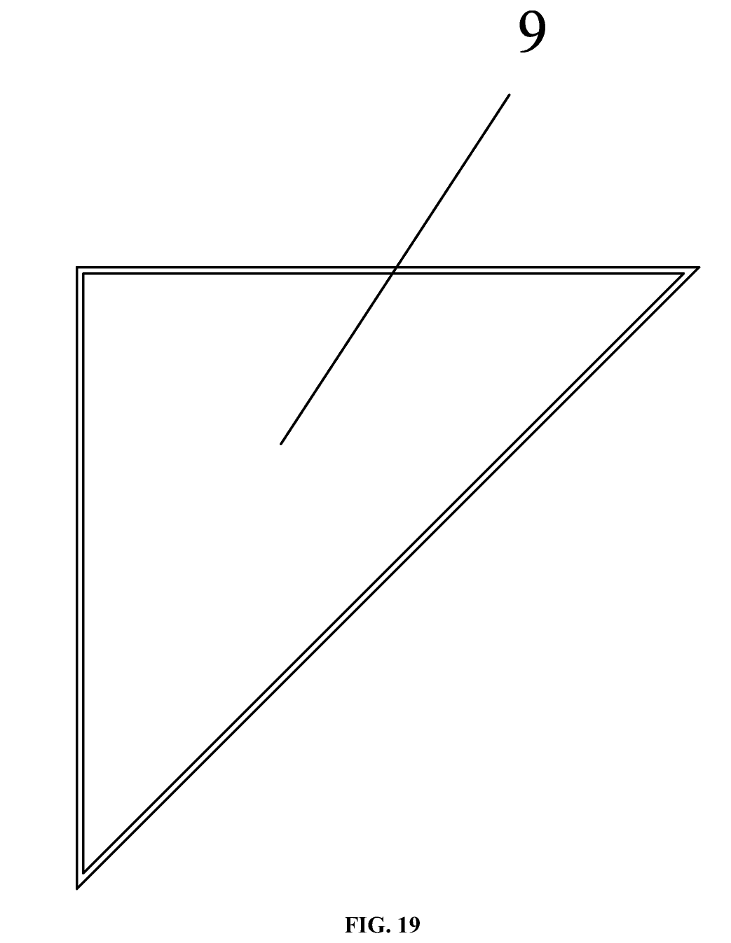

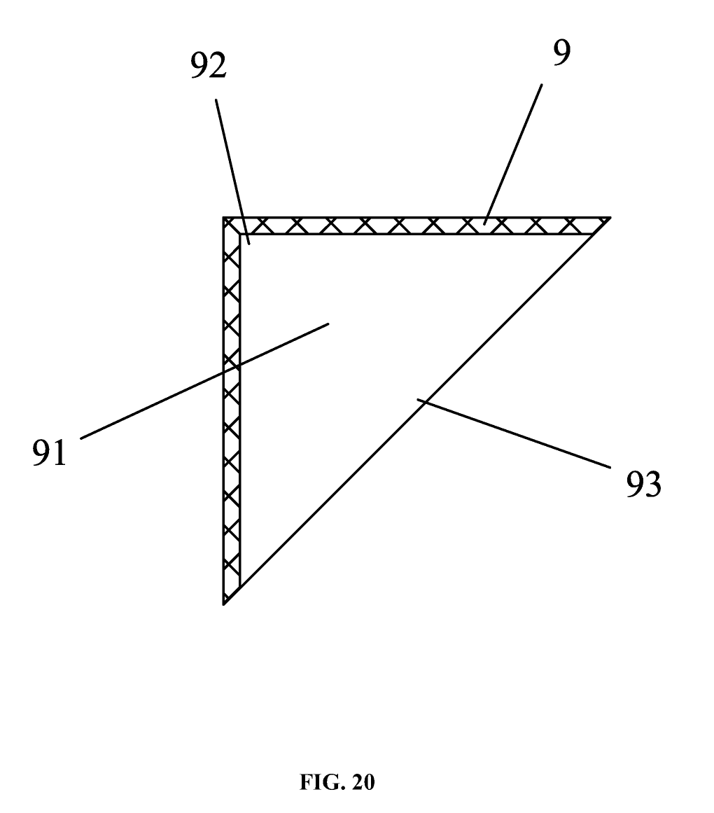

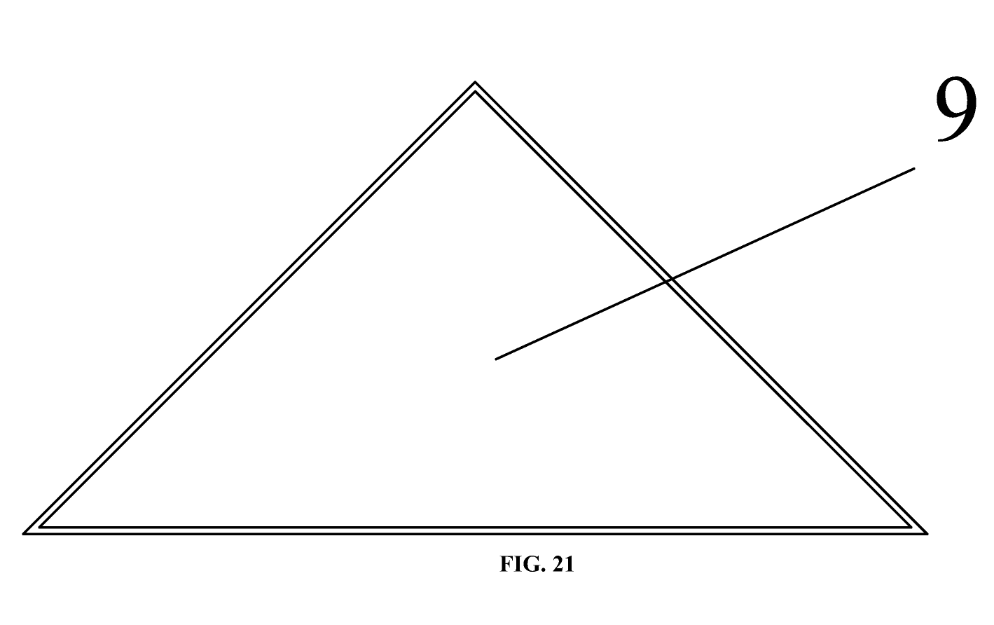

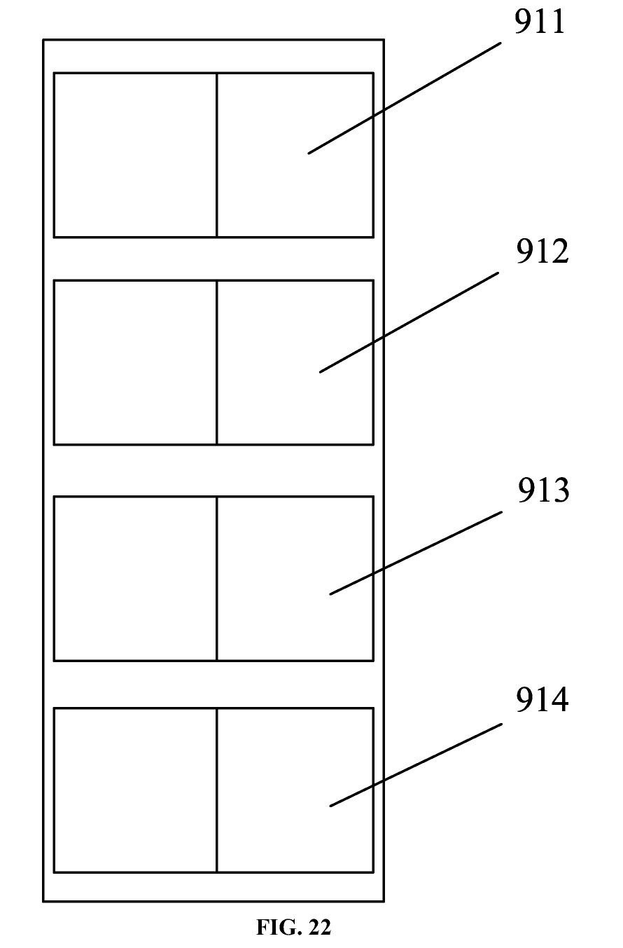

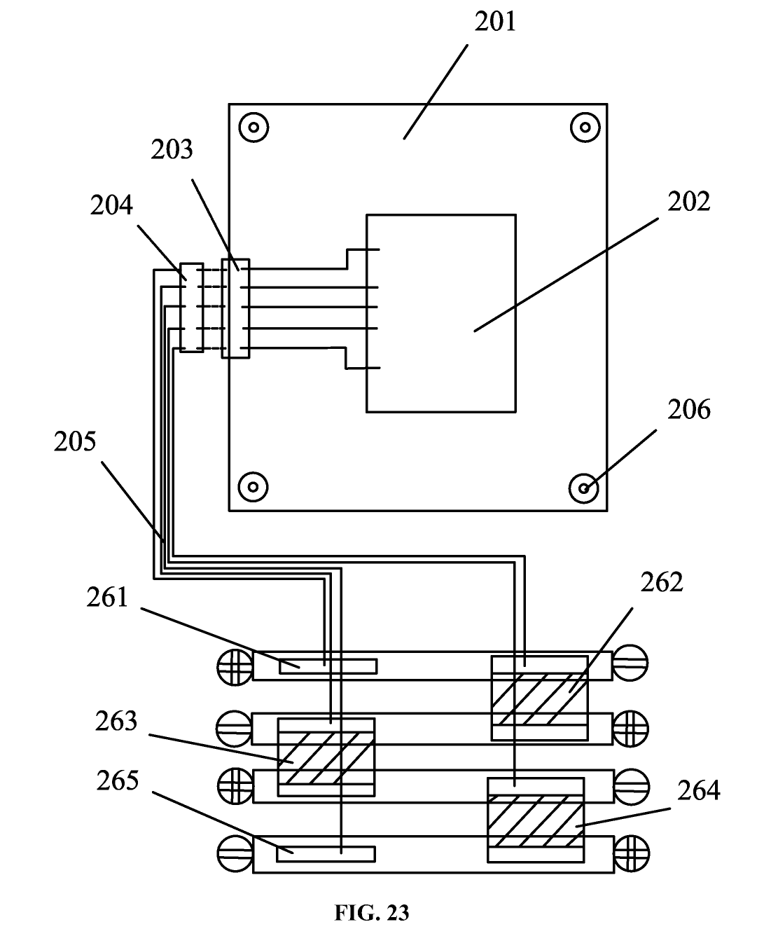

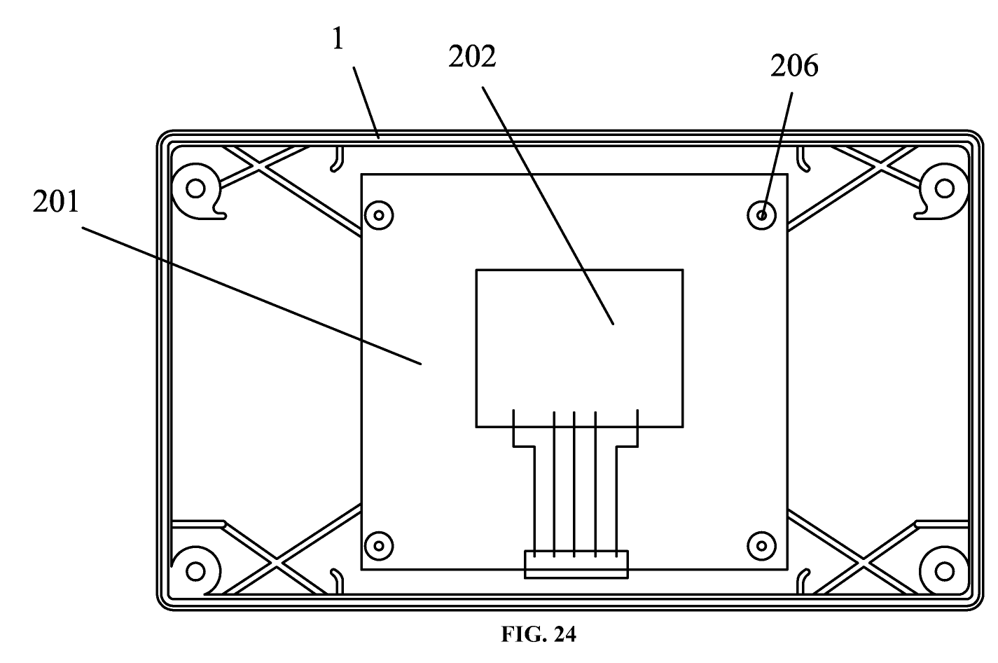

As shown in FIGS. 10-24, a lithium-ion battery specially used for starting motorcycles, in accordance with the invention, comprises a can 1, a cover 2, a cell assembly 3, a cell bracket 4, a positive lead, a negative lead, a positive terminal 61, a negative terminal 62, insulation sleeves, four fixed screws, seal rings, six support cushions 72, in which the cell assembly 3 comprises four 3.2 V lithium-ion cells in series via a patch panel 33. The four lithium-ion cells are parallel and overlap with one another and the two adjacent lithium-ion cells form a clearance 34, having the same structure as described in Example 1. The cell assembly 3 is arranged with a positive electrode 31 and a negative electrode 32 and each clearance 34 between the two adjacent lithium-ion cells is arranged with a long support cushion 72.

The cell bracket 4 comprises four bracket bodies 9 and each bracket body 9 is in the shape of a triangular prism and each bracket body 9 is arranged with a four-layer cavity 91. The four-layer cavity 91 comprises a No. 1 cavity 911, a No. 2 cavity 912, a No. 3 cavity 913 and a No. 4 cavity 914, which overlap with one another. In this example, the cavity 91 is in the shape of a right triangular prism and the bottom of the cavity 91 is in the shape of an isosceles right-angled triangle, i.e. a right angle 92 exists at the bottom of the cavity 91. The bottom of the cavity 91, in accordance with the invention, can be arranged into other types of right angles according to actual conditions apart from the isosceles right-angled triangle. The cavity 91 is arranged with an inlet 93, which is opposite to the right angle 92 of the right triangle of the cavity 91, i.e. the inlet 93 is opposite to the right angle 92. The bracket bodies 9 in this example can be made into standard parts, but more importantly, they are preferably designed into 4-6 different specifications according to the height of the cavity 91, thus the bracket bodies 9 can be applied to different starting batteries with hundreds of specifications. Consequently, more materials are saved and fewer moulds are required and the costs on moulds and mould making are reduced. Moreover, the applicability of the bracket bodies 9 is extended and versatility is improved.

The cell assembly 3 is mounted on the cell bracket 4, i.e. four lithium-ion cells are mounted on the cell bracket 4. The four lithium-ion cells overlap with one another and four angles of each lithium-ion cell are separately mounted in the cavity 91 at the same level in the four bracket bodies 9, for example, the four angles of the first lithium-ion cell are mounted in the No. 1 cavity 911 of the four bracket bodies 9, the four angles of the second lithium-ion cell are mounted in the No. 2 cavity 912, the four angles of the third lithium-ion cell are mounted in the No. 3 cavity 913, and four angles of the fourth lithium-ion cell are mounted in the No. 4 cavity 914. Insert the four angles of the lithium-ion cell into the cavity 91 through the inlet 93 and enable each angle of the lithium-ion cell to overlap with the right angle 92 of the cavity 91, therefore the lithium-ion cells can be securely mounted in the cell bracket 4. The four lithium-ion cells, in accordance with this example, are in parallel with one another. The space between lower surfaces of the four angles of each lithium-ion cell and the bottom of the cavity 91 can be reinforced by adhesives, so that the lithium-ion cells can be securely fixed on the cell bracket 4. Normally, the upper surfaces of the four angles of each lithium-ion cell and the top of the cavity 91 form a certain clearance therebetween. Therefore the lithium-ion cells can be mounted on the cell bracket 4 as long as the lower surfaces of the four angles of each lithium-ion cell and the bottom of the cavity 91 are fixed. Consequently, the bracket bodies 9 can be made into standard parts to reduce production costs.

The positive terminal 61 and the negative terminal 62 are both fixed on the cover 2 by injection molding and they are both mounted with insulation sleeves. One end of the positive lead is fixed on the positive terminal 61 by screws and the other end is fixed on the positive electrode 31 of the cell assembly 3 while one end of the negative lead is fixed on the negative terminal 62 by screws and the other end is fixed on the negative electrode 32 of the cell assembly 3.

The can 1 is in the shape of an open-mouthed rectangular and it comprises a battery mounting chamber 11. The bottom of the battery mounting chamber 11 is arranged with a boss 12, matching the shape and size of the cell bracket 4. Two opposite inner walls of the battery mounting chamber 11 are respectively arranged with two raised bars extending from the bottom to the top of the battery mounting chamber 11 along its inner walls. The end of the raised bars curves in its raised direction to form four slots 15 that match the bracket bodies. The other two opposite inner walls of the battery mounting chamber 11 are respectively arranged with two columns 151 extending from the bottom to the top of the battery mounting chamber 11 along its inner walls. The other two opposite inner walls of the battery mounting chamber 11 are arranged with a limit plate 152 that extends from the bottom to the top of the battery mounting chamber 11 along its inner walls and which is between the two columns 151 and meanwhile close to one of the columns 151. The slots 15 and the limit plate 152 are used to fix the bracket bodies 9. Alternatively, the limit plate 152 may not be used in this example and the slots 15 can be used in four sides instead. Therefore, the cell bracket 4 can be conveniently and securely fixed in the battery mounting chamber 11, so that the cell assembly 3 can be easily mounted in the battery mounting chamber 11. The top of the can 1 is arranged with a round of complete waterproof groove 13, which is around the periphery of the top of the can 1. The waterproof groove 13 is in the shape of a rectangle. The seal rings, having the shape and size matching the waterproof groove 13, are embedded in and closely contact with the waterproof groove 13.

The can 1 is arranged with four through holes 14 and the bottom of the cover 2 is arranged with four blind holes 23 matching the through holes 14 of the can 1. The fixed screws can go through the blind holes 23 and the through holes 14 to fix the cover 2 on the can 1. In this example, the bottom of the cover 2 is also arranged with four locating convex blocks 22 and a round of complete waterproof raised bar 21. The shape and size of the waterproof raised bar 21 matches the waterproof groove 13 of the can 1. When the cover 2 is fixed on the can 1 by the fixed screws, the waterproof raised bar 21 is embedded in and closely contact with the waterproof groove 13. When the cover 2 is fixed on the can 1 by the fixed screws, the four locating convex blocks 22 arranged at the bottom of the cover 2 hold the cell bracket 4 to allow it to be securely fixed in the battery mounting chamber 11 of the can 1.

The cover 2 also comprises an equalization circuit board 201 and blind holes 206, in which the equalization circuit board 201 is fixed on the cover 2 through the blind holes 206 by screws. The equalization circuit board 201 is mounted above the cell assembly 3 and comprises an equalization circuit 202 and a 5-pin socket 203. The socket 203 matches a plug 204, which is further connected with one end of a connecting wire 205 and the other end of the connecting wire 205 is connected with isoelectric points 261, 262, 263, 264 and 265 of the cell assembly 3. As a result, the equalization circuit 202 is capable of measuring and controlling the voltage of four cells within the cell assembly 3 so as to achieve a balanced voltage among individual cells. The voltage difference is controlled within 0.1 V to prevent overcharging of the batteries, so that the battery pack is protected and its service life is prolonged. When starting lithium-ion battery moulds are designed, unified mounting dimensions of the cover 2 are applied, therefore the same size of the equalization circuit board 201 is designed to apply to almost all starting batteries. Therefore, fewer models are to be managed and manufacturing costs are reduced.

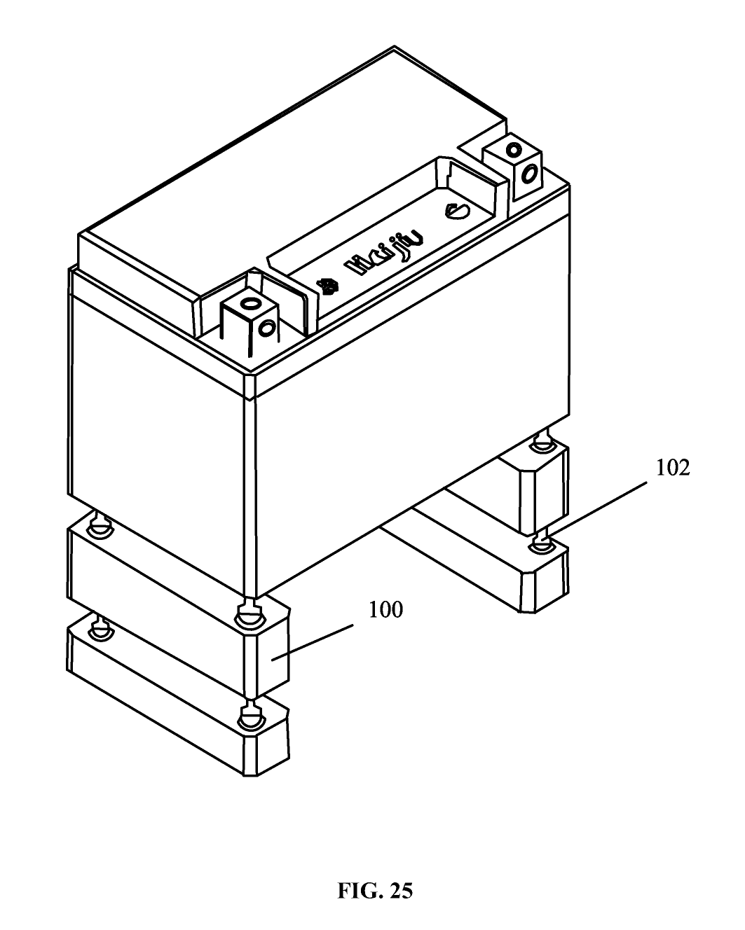

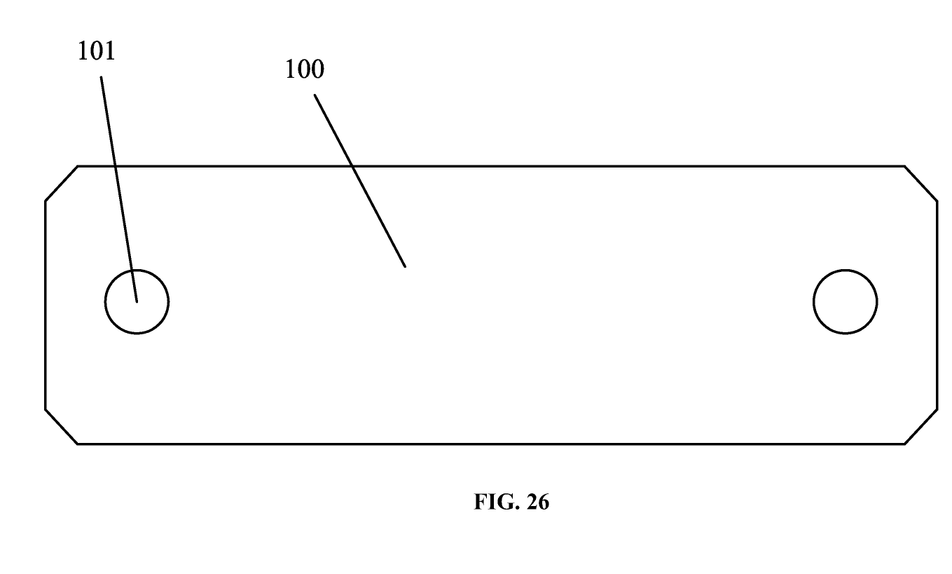

As shown in FIGS. 25 and 26, bases 100 can be optionally arranged at the bottom of the can 1. The lower surface of each base 100 is arranged with fixed holes 101 and the upper surface is arranged with support legs 102. When they are assembled, the support legs 102 are clamped in the through holes 14 and different sizes of the bases 100 can be mounted according to corresponding models of the batteries. The support legs 102 for different bases 100 can be inserted in the fixed holes 101 that are mounted on the bases 100. In order to change the dimensions of a battery, users may combine the bases 100 with different dimensions. Moreover, resistance cushions can also be mounted in the fixed holes 101 at the lower surface of the bases 100.

Because the inner space for mounting batteries is limited in a motorcycle, lead-acid batteries have almost hundreds of models and many models have the same length and width but the different height, therefore the low height batteries can be mounted in the spaces (the higher the space, the larger the capacity; motorcycles with different engine displacements need different capacity of batteries) that were previously used for batteries with higher height. Since the volumetric specific energy of a lithium-ion battery is three times of that of a lead-acid battery, it is possible to develop a plastic mould including the cover 2, the can 1 and the combinable bases 100 based on the dimensions of the shortest lead-acid battery to replace almost ten models of the lead-acid batteries having the same length and width. As a result, fewer technological equipment and moulds are required and battery costs are reduced.

Alternatively, the shape of the fixed support, in accordance with the above examples, may be in the shape of a “#” or parallel lines or others.

In the above examples, the number of the support cushions can be increased to nine or twelve. The support cushions are in a rectangular strip structure, two adjacent lithium-ion cells are arranged with three or four support cushions, which are parallel with one another. Due to the fact that the four lithium-ion cells are mounted on the cell bracket, in accordance with the invention, they have better anti-vibration performance and heat dissipation performance, especially when the four lithium-ion cells are mounted on the cell bracket horizontally. In such case, the support cushions can provide sufficient support and effectively prevent deformation of the lithium-ion cells, thus the performance of the lithium-ion battery provided by the invention is improved and its service life is prolonged.

The above examples are only explanatory to the structure of the lithium-ion battery provided by the invention. It will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. A lithium-ion battery, comprising:
a) a positive terminal;
b) a negative terminal;
c) an open-mouthed rectangular can;
d) a cover matching the can;
e) a cell assembly;
f) a positive lead;
g) a negative lead;
h) a cell bracket;
i) at least three support cushions; and
wherein
the positive terminal and the negative terminal are both fixed on the cover and the cover is fixed on the can;
the cell assembly comprising four lithium-ion cells in series is mounted on the cell bracket;
the support cushion is arranged between two adjacent lithium-ion cells, and a positive electrode and a negative electrode are arranged in the cell assembly;
one end of the positive lead is fixed on the positive terminal and the other end is fixed on the positive electrode of the cell assembly;
one end of the negative lead is fixed on the negative terminal and the other end is fixed on the negative electrode of the cell assembly; and
the cell bracket is mounted in the can.

2. The lithium-ion battery of claim 1, wherein the can comprises a battery mounting chamber;
the positive terminal and/or the negative terminal is arranged with an insulation sleeve, respectively, and the cell bracket is mounted in the battery mounting chamber;
the cell assembly comprises four 3.2 V lithium-ion cells in series and the four lithium-ion cells are parallel with one another;
the lithium-ion cells are all lithium iron phosphate batteries, a clearance is arranged between two adjacent lithium-ion cells and each clearance is arranged with at least one support cushion; and
a waterproof mechanism is arranged between the can and the cover.

3. The lithium-ion battery of claim 2, wherein the waterproof mechanism comprises a waterproof groove and a waterproof raised bar, in which the waterproof groove is arranged on the top of the can and the waterproof raised bar that matches the waterproof groove is arranged at the bottom of the cover; and
the waterproof raised bar is embedded in the waterproof groove.

4. The lithium-ion battery of claim 3, wherein the cell bracket comprises four bracket bodies and each bracket body is arranged with a four-layer cavity that is in the shape of a right triangular prism;
the bottom of the cavity is in the shape of a right triangle;
the four layers of the cavities in each bracket body overlap with one another;
each cavity comprises an inlet, which is opposite to the right angle of the right triangle of that cavity; and
four angles of each lithium-ion cell are separately mounted in the cavity at the same level in four bracket bodies.

5. The lithium-ion battery of claim 4, wherein
four slots are disposed on the inner wall of the battery mounting chamber; and
the four bracket bodies matching the four slots are clamped in the slots, respectively.

6. The lithium-ion battery of claim 5, wherein
two opposite inner walls of the battery mounting chamber are respectively arranged with two first raised bars extending from the bottom to the top of the battery mounting chamber along its inner walls;
the end of the first raised bar curves in its raised direction to form four slots that match the bracket bodies;
the other two opposite inner walls of the battery mounting chamber are respectively arranged with two columns extending from the bottom to the top of the battery mounting chamber along its inner walls;
at least one of the two columns has a second raised bar extending in the axial direction of that column;
the end of the second raised bar curves in its raised direction to form two limit raised bars that match the bracket bodies; and
the slots and the limit raised bars are used to fix the bracket bodies.

7. The lithium-ion battery of claim 5, wherein
two opposite inner walls of the battery mounting chamber are respectively arranged with two raised bars extending from the bottom to the top of the battery mounting chamber along its inner walls;
the end of the raised bars curves in its raised direction to form four slots that match the bracket bodies;
the other two opposite inner walls of the battery mounting chamber are respectively arranged with two columns extending from the bottom to the top of the battery mounting chamber along its inner walls;
the other two opposite inner walls of the battery mounting chamber are arranged with a limit plate that extends from the bottom to the top of the battery mounting chamber along its inner walls and which is between the two columns and meanwhile close to one of the columns; and
the slots and the limit plate are used to fix the bracket bodies.

8. The lithium-ion battery of claim 2, wherein
the lithium-ion battery further comprises bases, which are fixed at the bottom of the can; and
the bottom of the cover is arranged with a plurality of locating convex blocks, which hold the cell bracket.

9. The lithium-ion battery of claim 2, wherein
the positive terminal and the negative terminal are both fixed on the cover by injection molding; and
one end of the positive lead and the negative lead is fixed on the positive terminal and the negative terminal by screws, respectively.

10. The lithium-ion battery of claim 2, wherein four lithium-ion cells in the cell assembly are in the shape of a flat rectangle and overlap with one another.

11. The lithium-ion battery of claim 3, wherein the lithium-ion battery further comprises a seal ring matching the waterproof groove and the seal ring is mounted in the waterproof groove of the can.

12. The lithium-ion battery of claim 2, wherein
the lithium-ion battery further comprises a plurality of fixed screws and the can is arranged with matching through holes;
the through holes are perpendicular to the bottom of the can;
the upper end of each through hole is on the top of the can and the lower end is at the bottom of the can;
the bottom of the cover is arranged with blind holes matching the through holes; and
the cover is fixed on the can via the fixed screws and the fixed screws go through the through holes and the blind holes.

13. The lithium-ion battery of claim 6, wherein
the lithium-ion battery further comprises a plurality of fixed screws and the can is arranged with matching through holes;
the through holes are perpendicular to the bottom of the can;
the upper end of each through hole is on the top of the can and the lower end is at the bottom of the can;
the bottom of the cover is arranged with blind holes matching the through holes; and
the cover is fixed on the can via the fixed screws and the fixed screws go through the through holes and the blind holes.

14. The lithium-ion battery of claim 13, wherein the through holes are located at the center of the columns and extend through the whole columns in the axial direction of the columns

15. The lithium-ion battery of claim 2, wherein
the battery mounting chamber of the can is arranged with a wire duct matching the positive lead and the negative lead, which are both in the wire duct; and
the four lithium-ion cells in the cell assembly are connected in series via a patch panel or connecting wires.

16. The lithium-ion battery of claim 1, wherein the bottom of the can is arranged with a fixed support, which is used to heighten the cell bracket and which is in the shape of a “#”, “X”, or parallel lines.

17. The lithium-ion battery of claim 1, wherein the can or the cover is arranged with an equalization circuit, which is connected with the cell assembly by means of the connecting wires.

18. The lithium-ion battery of claim 4, wherein the bracket bodies are in the shape of a right triangular prism and two adjacent bracket bodies are coupled by reinforced ribs and/or tapes.

19. The lithium-ion battery of claim 18, wherein one right-angle side of the right triangular prism is closely against the inner wall of the can.

20. The lithium-ion battery of claim 8, wherein
one side of each base is arranged with a fixed hole and the opposite side is arranged with a support leg, which is fixedly coupled to the fixed hole at the outer bottom of the can; and
the adjacent bases are fixedly coupled together by the support leg and the fixed hole on the bases.
